(19) United States
(12) Patent Application Publication
(10) Pub. No.: US 2021/0126233 A1
(43) Pub. Date: Apr. 29, 2021

(54) HIGH-VOLTAGE BATTERY OF A MOTOR VEHICLE

(71) Applicant: VOLKSWAGEN AKTIENGESELLCHAFT, Wolfsburg (DE)

(72) Inventor: Mirko HERRMANN, Wolfsburg (DE)

(73) Assignee: VOLKSWAGEN AKTIENGESELLCHAFT, Wolfsburg (DE)

(21) Appl. No.: 17/082,335

(22) Filed: Oct. 28, 2020

(30) Foreign Application Priority Data
Oct. 28, 2019 (DE) 10 2019 216 545.1

(51) Int. Cl. H01M 2/20; H01M 2/30; B60K 6/28; B60L 50/60; B60L 3/00; B60L 58/18

(52) U.S. Cl. CPC H01M 2/206; H01M 2/305; B60K 6/28; B60L 50/60; B60Y 2400/112; B60L 58/18; H01M 2220/20; B60Y 2200/91; B60Y 2200/92; B60L 3/0046

(57) ABSTRACT

A high-voltage battery of a motor vehicle has a number of battery cells electrically contacted with one another, each having a housing with a positive terminal and a negative terminal. A first conductor electrically contacted with the positive terminal and a second conductor electrically contacted with the negative terminal are arranged in each housing. A number of galvanic elements, each having a cathode, an anode and a separator arranged therebetween, are electrically connected in series between the conductors, adjacent galvanic elements abutting one another via a bipolar plate. A remotely operated switch is connected between one of the conductors and the associated terminal to a control input, which is in electrical contact with a control terminal of the housing. The invention also relates to a method for operating a high-voltage battery and a battery cell of a high-voltage battery.

### CROSS REFERENCE TO RELATED APPLICATION

This application claims priority from German Patent Application No. 10 2019 216 545.1, filed Oct. 28, 2019, which is incorporated herein in its entirety.

### FIELD OF THE INVENTION

The invention relates to a high-voltage battery of a motor vehicle. The motor vehicle is in particular an electric vehicle and is therefore electrically driven. Here, the high-voltage battery serves in particular as an energy store for supplying an electric motor drive of the motor vehicle. The invention also relates to a method for operating a high-voltage battery of a motor vehicle.

### BACKGROUND OF THE INVENTION

Motor vehicles are increasingly being designed electrically, for example, as a hybrid motor vehicle or as a fully electric vehicle, and therefore have a high-voltage battery. By means of these, an electric motor is fed during operation, which is used to drive the motor vehicle. When the motor vehicle accelerates, a relatively large amount of power is drawn from the high-voltage battery. In order for the weight of the electrical lines between the high-voltage battery and the electric motor to not be increased excessively, as is necessary in the case of a relatively high current carrying capacity, the high-voltage battery provides a relatively high electrical direct voltage, which is usually between 400 V and 800 V.

The high-voltage battery therefore includes a certain number of galvanic elements that are suitably interconnected to provide the predetermined electrical voltage. In order to achieve a relatively high energy density for a given installation space, lithium-ion elements are usually used as galvanic elements. In order to allow scalability and assembly of the high-voltage battery, the galvanic elements are divided into battery cells of identical design, also referred to as (battery) modules, each of which has a closed housing with two terminals. The respective galvanic elements, which are suitably interconnected to provide a specific electrical voltage, are arranged within each housing. The galvanic elements are also electrically contacted with the two terminals, so that the electrical voltage provided by means of the galvanic elements is applied to them during operation.

The battery cells in turn are suitably interconnected with one another, the electrical voltage provided by the high-voltage battery being determined by means of the interconnection. In order to allow a relatively high power requirement of the high-voltage battery and in so doing avoid an excessive heating, it is necessary for the interconnection of the individual battery cells to have a relatively low resistance. For this reason it is necessary that there is a relatively low contact resistance therebetween. That is why metal plates are mostly used, which are welded to the corresponding terminals.

If there is a defect in one of the galvanic elements and thus in the respective battery cell or another defect in the battery cell, it is necessary to first shut down the motor vehicle, disconnect the metal plates and remove the defective battery cell. This means that there is a relatively large amount of effort. In the period between the detection of the defect in the battery cell and the removal of the defective battery cell, it is also possible for the defective battery cell to affect other battery cells, which can lead to malfunction of the complete high-voltage battery. In this case, electrical power is usually still stored in the defective battery cell and the other battery cells of the high-voltage battery surrounding the defective battery cell, which increases the damage if the malfunction occurs. Operational safety is thus reduced.

### SUMMARY OF THE INVENTION

The object of the invention is to specify a particularly suitable high-voltage battery for a motor vehicle and a particularly suitable method for operating a high-voltage battery of a motor vehicle as well as a particularly suitable battery cell of a high-voltage battery, an operational reliability being advantageously increased.

With regard to the high-voltage battery, this object is achieved according to the invention as claimed, with regard to the method as claimed and with regard to the battery cell as claimed. Advantageous further developments and designs are the subject matter of the respective subclaims.

The high-voltage battery is a part of a motor vehicle. The motor vehicle is preferably land-based and preferably has a number of wheels, of which at least one, preferably a plurality thereof, or all of them are driven by means of a drive. One of, preferably a plurality of, the wheels is suitably designed to be controllable. It is thus possible to move the motor vehicle independently of a specific roadway, for example rails or the like. In this case, it is expediently possible to position the motor vehicle essentially at will on a roadway that is made in particular from asphalt, tar or concrete. The motor vehicle is, for example, a commercial vehicle, such as a truck or a bus. However, it is particularly preferred that the motor vehicle is a passenger car.

In particular, the motor vehicle has a drive by means of which the motor vehicle moves. For example, the drive, in particular the main drive, is at least partially designed electrically, and the motor vehicle is, for example, an electric vehicle. The motor vehicle thus has an electric motor for propulsion. The electric motor is operated by means of the high-voltage battery. An electrical converter is preferably arranged between the high-voltage battery and the electric motor, by means of which the current supply to the electric motor is set. In one alternative, the drive also has an internal combustion engine, so that the motor vehicle is designed as a hybrid motor vehicle.

An electrical direct voltage is expediently provided by means of the high-voltage battery, the electrical voltage being, for example, between 200 V and 800 V and, for example, essentially 400 V. The high-voltage battery has a number of battery cells, that is to say two, three or more battery cells, which are expediently structurally identical to one another. The battery cells, each also referred to as a battery module, module or cell, are in electrical contact with one another, preferably by means of cell connectors, a metal plate in each case preferably being used as the cell connector. The high-voltage battery suitably comprises a battery housing within which all the battery cells are arranged, which increases safety. The battery housing is preferably made of a metal, for example a steel, such as a stainless steel, or an aluminum and/or in a die-casting process. In particular, the battery housing is designed to be closed. An interface that forms a terminal for the high-voltage battery is expediently introduced into the housing. The interface is thus electrically contacted with the battery cells so that electrical power can be fed into the battery cells and/or electrical power can be drawn from the battery cells from outside the high-voltage battery, provided that a corresponding connector is plugged into the terminal. Here, the plug is preferably a part of a power supply line of the motor vehicle. The high-voltage battery and therefore also the battery cells are thus expediently designed to be rechargeable.

Each of the battery cells has a housing that includes a positive terminal and a negative terminal. In the assembled state, one of the possible cell connectors is electrically contacted with the terminals and suitably welded to them. The terminals are preferably made from a metal, for example a copper, and preferably have a relatively low specific resistance. The remainder of the housing is made, for example, from a plastic or particularly preferably from a metal, such as a steel, in particular stainless steel, or an aluminum. A die casting process is preferably used for production. The terminals are electrically insulated from the other components of the housing, and are preferably surrounded by a plastic ring or the like. The housing is expediently closed, so that the penetration of foreign particles into the housing is prevented.

A number of galvanic elements are arranged in the housing, one of the galvanic elements being in electrical contact with a first conductor and another of the galvanic elements being in electrical contact with a second conductor. The first conductor is electrically contacted with the positive terminal, and the second conductor is electrically contacted with the negative terminal. For example, the conductors are formed in one piece with the respective galvanic element or by means of the respective galvanic element. As an alternative to this, these are separate components or they are molded onto the respective terminals and are therefore integral with them. Each galvanic element has a cathode, an anode and a separator arranged between them. In addition, adjacent galvanic elements are each connected to one another via a bipolar plate and expediently thereby abut one another. Thus, a stacked structure of cathode, separator, anode and bipolar plate is formed, the cathode of the next galvanic element abutting the bipolar plate. Thus, all galvanic elements are electrically connected in series. In particular, the conductors form the end of the interconnection of the galvanic elements. Due to the interconnection, the electrical voltage provided by each of the galvanic elements is increased. The electrical voltage provided by means of each battery cell is thus equal to the multiple of the electrical voltage provided by means of one of the galvanic elements, the multiple being equal to the number of galvanic elements.

Each battery cell also has a remotely operated switch which is arranged within the housing and is electrically connected between one of the conductors and the terminal associated with the conductor. The remotely operated switch has a control input, the switching state of the switch being set depending on an electrical potential applied across the control input. For example, the switch is a mechanical switch such as a relay or contactor. The switch is particularly preferably a semiconductor switch, such as a MOSFET, an IGBT or a GTO. The control input is electrically contacted with a control terminal of the housing. The control input is expediently designed in the same way as the first/second terminal and/or preferably surrounded by a plastic ring so that it is electrically insulated from other components of the housing. It is thus possible to operate the remotely operated switch from outside the housing, namely by applying a corresponding electrical voltage/potential to the control terminal. For example, the control input is formed by means of only a single terminal, and the control terminal thus only has a single terminal. In this case, any electrical potential applied across the assigned terminal or the assigned conductor serves in particular as a reference potential for controlling the switch. As an alternative to this, both the control input and the control terminal each have two terminals, the respective reference potential being provided by means of one of the terminals.

Since the remotely operated switch is present, it is possible to electrically disconnect the galvanic elements from the respective terminal from outside the battery cell, so that there is no longer any electrical potential difference between the two terminals. It is therefore possible to disconnect one of the battery cells from the remaining battery cells of the high-voltage battery so that this battery cell is no longer used to operate the high-voltage battery. In other words, it is possible to switch off one of the battery cells. It is possible in particular here to disconnect a defective battery cell from the other battery cells when the motor vehicle is in operation, so that safe operation of the high-voltage battery is still possible, albeit with a reduced capacity. Since the galvanic elements are electrically connected in series within the housing, it is necessary to switch a relatively large electrical voltage. In this case, however, the electrical current carried by the remotely operated switch, hereinafter also referred to only as “switch,” is relatively low, so that a relatively inexpensive component can be used for this. Since the switch is also located inside the housing of the battery cells, the other components of the high-voltage battery are disconnected from it by means of the housing and are therefore insulated. This prevents damage to it in the event of a failure of the switch and/or the propagation of an arc due to the switching process. The switch also does not affect the cell connectors, which is why the terminals of adjacent battery cells can be connected with relatively low resistance, which increases the efficiency of the high-voltage battery.

For example, the switch is closed when no signal, in particular no electrical voltage, is applied across the control terminal. However, the switch is particularly preferably open when no signal, in particular no electrical voltage or electrical potential, is applied across the control terminal. In the event of a faulty activation of the control terminal, for example due to a break in an electrical line connected to it, the respective battery cell is disconnected from the further battery cells of the high-voltage battery, which is why safety is increased. For example, the high-voltage battery has only such battery cells. In an alternative to this, the high-voltage battery also includes further battery cells, these battery cells not having a remotely operated switch. In particular, the high-voltage battery is formed by means of the battery cells, all of the battery cells expediently each having the switch. As an alternative to this, the high-voltage battery also includes additional components, such as a battery management system, by means of which charging and discharging of the individual battery cells is set and/or monitored. Any battery management system (BMS), is preferably arranged within the battery housing, if present.

The galvanic elements also preferably comprise an electrolyte, electrolytes of the adjacent galvanic elements being suitably disconnected from one another by means of the respective bipolar plate. For example, the electrolyte is a liquid or gel electrolyte. The galvanic element are suitably lithium-ion accumulators, which increases the energy density for a given weight. In particular, the separator is made from a polyolefin membrane. For example, the bipolar plate is made of aluminum, one of the sides facing the associated galvanic elements being coated with nickel. As an alternative to this, the bipolar plate comprises in particular a nickel foil that is applied to a further component or by means of which the bipolar plate is formed. In another alternative, the bipolar plate is made of pure copper or nickel.

Each galvanic element suitably comprises a plastic frame, or at least one such plastic frame is assigned to each of the galvanic elements. The plastic frame is suitably substantially rectangular. For example, the plastic frame is made of a polypropylene (PP), a polyethylene (PE), a polyamide (PA), an acrylonitrile-butadiene-styrene copolymer (ABS), a polylactide (PLA), a polymethyl methacrylate (PMMA), a polycarbonate (PC), a polyethylene terephthalate (PET), a polystyrene (PS), a polyvinyl chloride (PVC), a polyphenylene sulfide (PPS), a polyphenylene ether (PPE), a polyetherimide (PEI), a polyetheretherketone (PPEK), a polyethersulfone (PES), a polybenzimidazole (PBI), a nylon or a composite.

For example, the anode is accommodated by means of the plastic frame so that it is surrounded by the plastic frame. However, the respective cathode is particularly preferably accommodated by the plastic frame, which thus surrounds the cathode along the circumference. The cathode expediently does not protrude beyond the plastic frame and is therefore flush with it. Furthermore, each separator is attached at the end to the respective plastic frame. This also facilitates the attachment and the introduction of the cathode. The plastic frame is suitably closed by means of the bipolar plate on the side opposite the separator, so that the cathode or the anode is securely held within the plastic frame. The anode is preferably also connected to the separator. It is thus possible to provide the individual galvanic elements as a respective module, which simplifies assembly and their manufacture. Each plastic frame is suitably connected to a rack and, for example, pushed into corresponding receptacles in the rack and/or fastened to it. The rack is used to stabilize the plastic frame and thus also the complete galvanic elements. Particularly preferably, separate spaces are created between the individual plastic frames and by means of the rack, each of which is filled with the corresponding electrolyte of the associated galvanic element. In particular, the spaces are separated from one another by means of the rack and the plastic frame, so that the electrolytes cannot cross over to adjacent galvanic elements. This increases operational reliability.

For example, the switch is placed between the second conductor and the negative terminal. It is particularly preferred, however, for the switch to be connected between the first conductor and the positive terminal and thus introduced between them. As a result, it is possible to disconnect the positive potential of the battery cell from the high-voltage battery. The negative terminal is suitably routed electrically to ground, so that an electrical reference potential continues to exist for each battery cell, namely ground, regardless of the state of the switch.

For example, there is only a single switch. Particularly preferably, however, each battery cell has a further remotely operated switch which, for example, is identical in design to the remotely operated switch or differs from it. The further remotely operated switch is expediently a MOSFET, an IGBT or GTO and has a further control input. The further remotely operated switch is connected between the negative terminal and the second conductor when the switch is connected between the positive terminal and the first conductor. It is thus possible to electrically disconnect all galvanic elements of the respective battery cell from the terminals by operating the switch and the further switch, so that no electrical voltage is applied across the terminals of this battery cell, or so that it is at least not affected by the galvanic elements of this battery cell. All galvanic elements of those battery cells whose switches are open are thus disconnected from the other components of the high-voltage battery and/or the motor vehicle, which is why safety is increased.

For example, the control input of the further switch is electrically contacted with a further control terminal of the housing, the further control terminal preferably being identical in design to the control terminal. It is thus possible to operate the switch and the further switch separately from one another. Particularly preferably, however, the further control input is electrically contacted with the (single) control terminal of the housing. Thus, when a signal is applied to the control terminal, both the switch and the further switch are actuated, which is why it is relatively easy to switch off the battery cells and leads to a relatively safe state.

For example, the battery cells are electrically connected in series to one another, or at least some of the battery cells are electrically connected in series to one another. However, the battery cells are particularly preferably connected electrically in parallel to one another. Thus, when one of the switches is opened, only this battery cell is disconnected (switched off) from the other components of the high-voltage battery, and the electrical voltage applied at the high-voltage battery is not affected. Only the capacity of the battery cell is reduced, namely by the amount that the disconnected battery cells would otherwise provide. The high-voltage battery can therefore also be operated when the switch is open on one or more of the battery cells. An electrical direct voltage of 400 V to 800 V is preferably provided by means of each of the battery cells. In particular, for this purpose, each of the battery cells has a corresponding number of galvanic elements that are electrically connected in series. In this case, all galvanic elements of each battery cell are preferably connected electrically in series to one another. It is thus possible for a relatively large electrical voltage to be provided by means of each of the battery cells. As an alternative to this, each battery cell comprises a plurality of strands or the like, the galvanic elements in each of the strands being electrically connected in series to one another, and the individual strands being electrically connected in parallel between the two conductors.

The method is used to operate a high-voltage battery in a motor vehicle. The motor vehicle is, for example, a land-based motor vehicle and is expediently designed as a multitrack track vehicle. The motor vehicle is, for example, a commercial vehicle. However, it is particularly preferred that the motor vehicle is a passenger car. As an alternative to this, the motor vehicle is, for example, a single-track vehicle and, for example, a motorcycle. The motor vehicle expediently comprises an electric drive which is electrically connected to the high-voltage battery, in particular via a converter. The drive is thus supplied with current by means of the high-voltage battery. It is also possible in this way to feed power into the high-voltage battery, especially if the drive is operated as a generator. The drive acts in particular on any wheels of the motor vehicle. For example, the drive is formed by means of an electric motor or a plurality of electric motors. As an alternative to this, the drive additionally comprises an internal combustion engine, by means of which the electric motors or the electric motors are assisted.

The high-voltage battery has a number of battery cells electrically contacted with one another, each battery cell comprising a housing having a positive terminal and a negative terminal. A first conductor, which is electrically contacted with the positive terminal, and a second conductor, which is electrically contacted with the negative terminal, are arranged in each housing. A number of galvanic elements are electrically connected in series between the conductors, each of which has a cathode, an anode and a separator arranged in between, adjacent galvanic elements abutting one another via a bipolar plate. A remotely operated switch having a control input is connected between one of the conductors and the associated terminal and is in electrical contact with a control terminal of the housing.

The method provides that a check is made of whether a condition is present. Then if the condition is met, one of the battery cell switches is opened. For this purpose, in particular, a corresponding signal is applied to the control terminal so that the respective switch is opened. Due to the method, it is thus possible to disconnect individual battery cells of the high-voltage battery from further components of the high-voltage battery and thus the motor vehicle. At least, however, an electrical voltage of the high-voltage battery and/or its capacity is restricted when the switch is opened. The term “disconnect” is understood to mean, in particular, the disconnection of the respective galvanic elements of the battery cell concerned from the other components of the motor vehicle. The connections present outside the battery cell expediently remain unchanged. Then, when the condition is met, for example only one, a plurality of, or all switches of the high-voltage battery are actuated, one of the battery cells being disconnected from the other components of the high-voltage battery with each open switch. In particular, the battery cells are combined into different groups so that the high-voltage battery is segmented. In particular, a separate condition is assigned to each of the groups, and the existence of different conditions is checked. If one of the conditions is met, the respectively assigned group of battery cells is disconnected by actuating their respective switches.

The high-voltage battery suitably comprises a control unit, by means of which the method is carried out at least partially. The control unit is therefore suitable, in particular provided and set up, to at least partially carry out the method. The control unit suitably comprises a microprocessor which is designed, for example, to be programmable. Alternatively or in combination with this, the control unit comprises an application-specific circuit (ASIC). For example, the condition is detected by means of the control unit. In particular, any bus system of the motor vehicle reads out whether the condition is present. For this purpose, the high-voltage battery, suitable control unit, is connected for signaling to the bus system.

For example, the execution of an assembly is used as a condition. In other words, if one or more of the battery cells are connected to form the high-voltage battery, at least one of the switches is opened. After each battery cell has been charged and/or discharged for the first time, an electrical potential is applied across the respective terminals when the switch is closed, which represents a safety risk for the person performing the assembly. It is also possible that the surroundings or other components of the motor vehicle come into electrical contact with the terminals and/or bypass them. Due to the actuation of the switch, namely the opening of the switch, this risk is reduced. In particular, all switches of the high-voltage battery are opened so that no electrical voltage is applied at the complete high-voltage battery. Damage is thus avoided even if the battery cells and the cell connectors are carelessly or improperly arranged. In addition, assembly is made easier since it does not have to be ensured that no further component comes into electrical contact with one of the terminals of the battery cells.

Alternatively or in combination with this, maintenance of the high-voltage battery is used as a condition, that is to say when, for example, the electrolyte is refilled or the battery cells are visually checked for damage. For example, during maintenance only the switch of the battery cell that is being serviced is opened. However, it is particularly preferred that all switches are opened so that all battery cells are disconnected and so that no electrical voltage is provided by means of the high-voltage battery. Since there is no electrical voltage between the terminals of the battery cells, maintenance is simplified.

As an alternative to this, a malfunction of one of the battery cells is used as a condition. In this case, the method provides in particular that the malfunction is first detected, for example, by means of a corresponding sensor. The malfunction is due to mechanical damage and/or electrical overload, for example. The malfunction is, for example, a short circuit in the battery cell, in particular due to an internal malfunction of the galvanic elements. Alternatively, the short circuit occurs due to a foreign body.

For example, when the malfunction is detected, the affected battery cell is disconnected from the other components of the high-voltage battery and thus the motor vehicle by opening of the switch. Particularly preferably, however, all remaining battery cells are first disconnected by opening the respective switch, so that the malfunctioning battery is first discharged when power is drawn from the high-voltage battery. If the motor vehicle is moved and an electric motor is used for this purpose, the electric motor is therefore initially fed by the faulty battery cell until it is discharged. Following this, the switch of the faulty battery cell is opened and the switches of the remaining battery cells are closed so that the motor vehicle can continue to be operated without interference. In a subsequent further operation of the motor vehicle, the switch of the faulty battery cells expediently remains open until the high-voltage battery is checked in its workshop. Here, for example, the faulty battery cell is replaced.

If the motor vehicle is not moving, or if electrical power could be fed back into the high-voltage battery, for example due to a generator in operation of the electric motor, the high-voltage battery appropriately sends a request to retrieve the stored electrical power and preferably feeds it into any bus system of the motor vehicle. An auxiliary unit of the motor vehicle, for example a heater, such as a seat heater or a window heater, such as a front window heater or a rear window heater, is then expediently operated depending on the request. Alternatively or in combination, an electric air conditioning system or an exterior mirror is operated. The electrical power stored in the faulty battery cell is therefore not used to meet a request from a user. Due to the discharging, however, a subsequent overloading of the battery cell and thus the high-voltage battery, which could lead to a thermal failure, is avoided. Here, too, if the battery cell is discharged or the electrical power stored therein falls below a limit value, the switch is opened and the switch expediently remains open until maintenance or replacement by a workshop or the like takes place.

For example, only the battery cell that has the malfunction is disconnected by means of the switch, in particular after the battery cell has been discharged. Particularly preferably, however, adjacent battery cells surrounding the respective battery cell are also disconnected by the opening of their respective switches. In this case, these battery cells are preferably also initially discharged, and then the respective switches are actuated. By means of the surrounding battery cells, a distance from the malfunctioning battery cell and the other battery cells used for operating the high-voltage battery is thus created. This prevents the defective battery cell from heating up due to the battery cells that are still being used and vice versa by means of the battery cells that are additionally switched off, which increases safety.

Alternatively or in combination with this, the condition used is that a temperature of the high-voltage battery is lower than a limit value. For the method, the temperature of the high-voltage battery is first measured, for which purpose a corresponding sensor is expediently used. Alternatively, the temperature of the high-voltage battery is queried via the possible bus system of the motor vehicle. In a further alternative, the temperature of the high-voltage battery is derived using an ambient temperature, the ambient temperature preferably being queried via the bus system. If the temperature is lower than the limit value, one of the switches, preferably a plurality of the switches, of the high-voltage battery is opened, at least one of the switches remaining closed. The limit value is, for example, 10° C., 0° C., −5° C. or −10° C. In particular, the temperature falls below the limit value when the motor vehicle is started, for example if the motor vehicle has been stationary for a certain period of time, such as 1 hour, 2 hours, 5 hours or 10 hours. In one alternative, it is assumed that the temperature falls below the limit value if the season is winter and the motor vehicle has been stationary for the specific period of time.

For example, a quarter, half or three quarters of all switches are opened, the remaining ones remaining closed, so that power is drawn from only three quarters, half or a quarter of the battery cells. The battery cells from which the power is drawn heat up, so that the temperature of the high-voltage battery is increased. The efficiency of the battery cells from which power is drawn is relatively low due to the low temperature and the increased power draw. Then, if the temperature of the high-voltage battery exceeds the limit value, all switches are closed, which is why power is drawn from all battery cells. Since all the battery cells now have a temperature that is greater than the limit value, the extraction of power is relatively efficient. Efficiency is also increased, since all battery cells are now available for the extraction of power.

For example, the same switches are always opened and the same switches remain closed when the temperature of the high-voltage battery is lower than the limit value. However, prior actuation of the switches is particularly preferably taken into account when the switches to be opened are selected. In particular, there is no opening of the switches that were opened when the condition was previously present, that is, when the temperature previously fell below the limit value. Thus, there is a successive change in the battery cells used for the first extraction of power or at least for extraction of power when the temperature is lower than the limit value, which is why excessive wear of only some of the battery cells is avoided. Rather, there is a balanced load, which is why the service life of the high-voltage battery is increased.

The invention also relates to a motor vehicle having such a high-voltage battery, which is operated in particular according to an aforementioned method.

The invention also relates to a battery cell of such a high-voltage battery. The battery cell thus has a housing with a positive terminal and a negative terminal, wherein a first conductor, which is electrically contacted with the positive terminal, and a second conductor, which is electrically contacted with the negative terminal, is arranged in the housing, between which terminals a number of galvanic elements are electrically connected in series, each having a cathode, an anode and a separator arranged therebetween, adjacent battery cells each abutting one another via a bipolar plate, and a remotely operated switch with a control input being connected between one of the conductors and the associated terminal which is electrically contacted with a control terminal of the housing. The housing is preferably made at least partially from a metal, the terminals, that is to say also the control terminal, being electrically insulated from further components of the housing.

The advantages and further developments described in connection with the high-voltage battery can also be applied to the method/motor vehicle/cell and to one another and vice versa.

### BRIEF DESCRIPTION OF THE DRAWINGS

Embodiments of the invention are explained in more detail below with reference to a drawing, in which:

FIG. 1 schematically simplifies a motor vehicle that has a high-voltage battery with a plurality of battery cells,

FIG. 2 is a schematic sectional view of one of the battery cells, which has a number of galvanic elements,

FIG. 3 simplifies one of the galvanic elements in a perspective view,

FIG. 4, 5 each show a further embodiment of the battery cell according to FIG. 2,

FIG. 6 shows a method for operating the high-voltage battery, and

FIG. 7-9 each schematically simplifies the high-voltage battery in different states.

Corresponding parts are provided with the same reference signs in all figures.

### DETAILED DESCRIPTION OF THE INVENTION

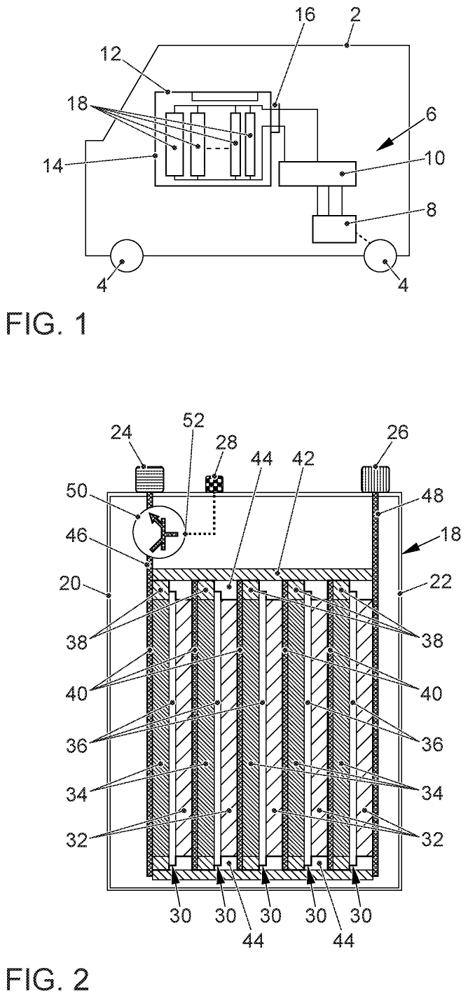

In FIG. 1, a motor vehicle 2 in the form of a passenger vehicle is shown in a schematically simplified manner. The motor vehicle has a number of wheels 4, at least some of which are driven by means of a drive 6 which comprises an electric motor 8. If only the electric motor 8 is present, the motor vehicle 2 is designed as an electric vehicle. In a variant not shown in detail, an internal combustion engine is also present, so that the motor vehicle 2 is a hybrid vehicle. The electric motor 8 is electrically connected to a high-voltage battery 12 via a converter 10, so that the electric motor 8 is supplied with current via the converter 10, which is fed by means of the high-voltage battery 10. If the electric motor 8 is operated as a generator due to a braking of the motor vehicle 2, electrical power is fed into the high-voltage battery 12 by means of the electric motor 8 and the converter 10.

The high-voltage battery 12 has a battery housing 14 made of a metal, namely a high-grade steel, an interface 16, to which the electric motor 8 is connected, being introduced into one side thereof. In an alternative, the battery housing 14 is made of a galvanized sheet metal or some other galvanized material, a lacquer preferably being applied to the zinc layer so that the battery housing 14 is painted. By means of the high-voltage battery 12, an electrical direct voltage of 400 V is provided at the interface 16. Arranged within the battery housing 14 of the high-voltage battery 10 are a plurality of battery cells 18 of identical design. The battery cells 18 are connected to a battery management system tern (not shown) which is also arranged in the battery housing 14. The electrical connection of the battery cells 18 to the interface 16 takes place via the battery management system, which is thus electrically connected to the interface 16. The battery cells 18 are electrically connected in parallel to one another, and the electrical voltage applied across the interface 16 is provided by means of each battery cell 18, namely 400 V. The electrical voltage applied across the interface 16 is therefore independent of the number of battery cells 18. The capacity of the high-voltage battery 12 is, however, determined by the number of battery cells 18 arranged in the battery housing 14.

In FIG. 2, one of the battery cells 18 that are of identical design is shown schematically simplified in a sectional view. The battery cell 18 has a housing 20 with a housing base body 22 which is made from an aluminum. Here, for example, a solid housing base body 22 is made from aluminum. In an alternative, an aluminum composite foil is used for this, which has an aluminum foil which is coated on one or both sides with one or more different plastics. The housing base body 22 is, for example, a so-called prismatic cell or “can cell.” In an alternative, the housing base body 22 is designed as a pouch cell.

In a further variant, the housing base body 22 is made from a high-grade steel in a die-casting process.

The housing base body 22 is essentially cuboid. Furthermore, the housing 20 has a positive terminal 24, a negative terminal 26 and a control terminal 28, which are made from copper and are introduced into the housing base body 22. In a further alternative, the positive terminal 24 is made of aluminum and the negative terminal 26 is made of pure copper or nickel-plated copper. Between the housing base body 22 and the terminals 24, 26, 28, an insulating ring (not shown) is arranged in each case, so that an electrical short circuit between the terminals 24, 26, 28 via the housing base body 22 is avoided. All positive terminals 24 of the battery cells 18 of the high-voltage battery 12 are in electrical contact with one another in the assembled state by means of cell connectors (not shown) to provide the parallel electrical connection. Likewise, all of the negative terminals 26 of the battery cells 18 for providing the electrical parallel connection are electrically connected by means of a common cell connector. The cell connections are each provided by means of a metal plate and welded to the associated terminals 24, 26, so that there is a relatively low electrical contact resistance between the individual battery cells 18.

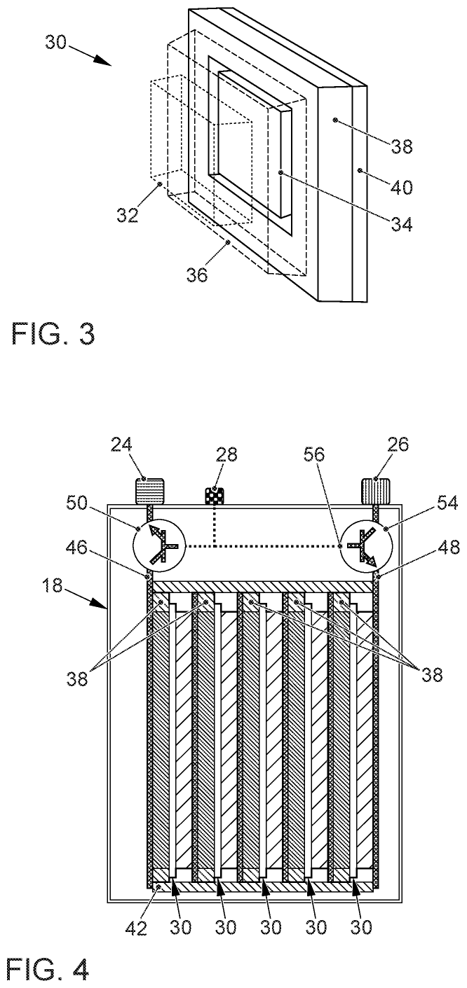

A plurality of galvanic elements 30 are arranged within the housing 20, five of which are shown in FIG. 2. Each galvanic element 30 is a lithium-ion accumulator and has a corresponding anode 32 and a cathode 34. A separator 36, which is provided by means of a polyolefin membrane, is arranged between each anode 32 and each cathode 34. Furthermore, each galvanic element 30 is assigned a plastic frame 38, which is essentially rectangular in shape and made from a polyethylene (PE). The respectively assigned cathode 34 is accommodated by means of each plastic frame 38, as shown in FIG. 3 in a transparent perspective view of one of the galvanic elements 30. In this context, the plastic frame 38 surrounds the assigned cathode 34 on the circumferential side, and the cathode 34 does not protrude beyond the plastic frame 38. The separator 36 is fastened to the plastic frame 38 so that the cathode 34 is stabilized within the plastic frame 38. The respective anode 32 is in turn attached to the separator 36. On the side of the plastic frame 38 opposite the separator 36, a bipolar plate 40 is attached to the plastic frame 38. The bipolar plate 40 is made from an aluminum plate coated with nickel on one side. In an alternative, the bipolar plate 40 is made of pure copper or nickel.

The galvanic elements 30 with the respectively assigned plastic frame 38 are manufactured as a structural unit and thus as a module, and for the assembly of the battery cell 18 are pushed into a rack 42 and attached to it. Here, the adjacent galvanic elements 30 abut one another via the respectively assigned bipolar plate 40. All galvanic elements 30 are thus electrically connected in series. The rack 42 is made of the same plastic as the plastic frames 38, and by means of the rack 42 the plastic frames 38 are completely surrounded along the circumference, so that chambers 44 are formed between the individual plastic frames 38 which are separate from one another. The chambers 44 are filled with an electrolyte (not shown in detail), the electrolyte being prevented from passing between adjacent chambers 44 by means of the plastic frame 38. The plastic frame 38 and the rack 42 are inert with respect to the electrolyte used. Because of the structure, the battery cell 18 is also referred to in particular as a bipolar stack cell.

A first conductor 46 is electrically contacted with one end of the electrical series connection of the galvanic elements 30 and a second conductor 48 is electrically contacted with the remaining end. The galvanic elements 30 are thus electrically connected in series between the two conductors 46, 48. The second conductor 48 is in direct electrical contact with the negative terminal 26. The first conductor 46 is in electrical contact with the positive terminal 24 via a switch 50 which is remotely operated and has a control input 52. In summary, the switch 50 is connected between the first conductor 46 and the positive terminal 24. A power semiconductor switch in the form of a MOSFET is used as switch 50.

The control input 52 of the switch 50 is in electrical contact with the control terminal 28 of the housing 20. The switch 50 is actuated depending on an electrical potential applied to the control terminal 28, so that a flow of electrical current from the first conductor 46 to the positive terminal 24 can be adjusted. In this case, the flow of electrical current to be switched by means of the switch 50 is relatively low, but the electrical voltage is equal to the electrical voltage provided by the high-voltage battery 12, namely 400 V.

A modification of the battery cell 18 depicted in FIG. 2 is shown in FIG. 4. In contrast to the previous embodiment, the second conductor 48 is now no longer connected directly to the negative terminal 26, but via a further switch 54, which is remotely operated and is identical in design to the switch 50 and thus has a further control input 56. The further control input 56 is also in direct electrical contact with the control terminal 28. Thus, when a corresponding electrical potential is applied to the control terminal 28, both the switch 50 and the further switch 54 are actuated and the electrical connection of the galvanic element 30 to the positive terminal 24 and to the negative terminal 26 is interrupted.

A modification of the battery cell 18 depicted in FIG. 4 is shown in FIG. 5. Here, too, the further switch 54 with the further control input 56 is present. However, this is no longer electrically contacted with the power terminal 28 of the housing 20 but with a further control terminal 58 of the housing, which is identical in design to the power terminal 28. However, there is no further change in the battery cell 18. It is thus possible to operate the two switches 50, 54 independently of one another.

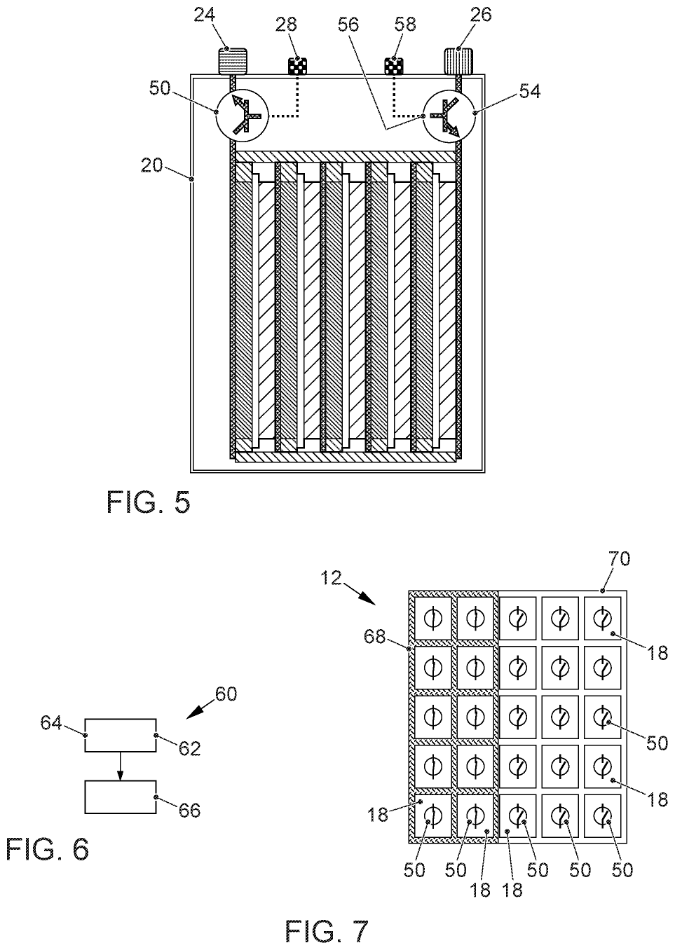

FIG. 6 shows a method 60 for operating the high-voltage battery 12. In a first work step 62, a check is made as to whether a condition 64 is present. If the condition 64 is met, a second work step 66 is carried out in which at least the switch 50 and/or the further switch 54, if these are present, of at least one of the battery cells 18 is operated, namely opened. This battery cell 18 is thus disconnected from the interface 16, so that electrical current can no longer flow from its respective terminals 24, 26 to the interface 16. The actuation of the switch 50 and any further switch 54 takes place depending on the respective condition 64 directly after the detection of the condition 64 or only after further work steps have been carried out.

In one embodiment of the invention, the execution of an assembly or maintenance of the high-voltage battery 12 is used as the condition 64. In this case, for example, the complete high-voltage battery 12 is to be removed from the motor vehicle 2, or individual battery cells 18 are to be replaced. It is also possible for the electrolyte to be refilled in the respective chambers 44 in at least one of the battery cells 18. As soon as the maintenance or assembly is started, all switches 50 and also all other switches 54 are opened, if they are present. As a result, the electrical voltage provided by the respective galvanic elements 30 is applied across none of the positive terminals 24 and also none of the negative terminals, which is why the work can be carried out undisturbed. This enhances safety. In other words, the method 60 is used to implement personal and work protection.

In one alternative, a temperature of high-voltage battery 12 being less than a limit value, which is 0° C., is used as condition 64. In this case, the high-voltage battery 12, which is shown schematically in FIG. 7 in this example and has twenty-five battery cells 18, is divided into two groups, a total of ten of the battery cells 18 being assigned to the first group 68. The second group 70, however, has the remaining fifteen battery cells 18. All switches 50 and any other switches 54 of the first group 68 remain closed, and the switch 50 and any other switches 54 of all the battery cells 18 assigned to the second group 70 are opened. The electrical power that can be drawn from the high-voltage battery 12 via the interface 16 is thus provided only by means of the battery cells 18 assigned to the first group 68. As a result, when power is subsequently drawn from the high-voltage battery 12, the battery cells 18 of the first group 68 are heated to a greater extent, the battery cells 18 of the second group 70 also being heated by means of the heat. If the temperature of the battery cells 18 of the second group 70 heated in this way is greater than the limit value or a further limit value, their switches 50 and any other switches 54 thereof are also closed, so that now the electrical power provided at the interface 16 is provided by means of all battery cells 18. In a further development, the condition 64 is only fulfilled internally if the motor vehicle 2 was stationary for a specific period of time, for example at least 2 hours, and if no power was drawn from the high-voltage battery 12 during this period.

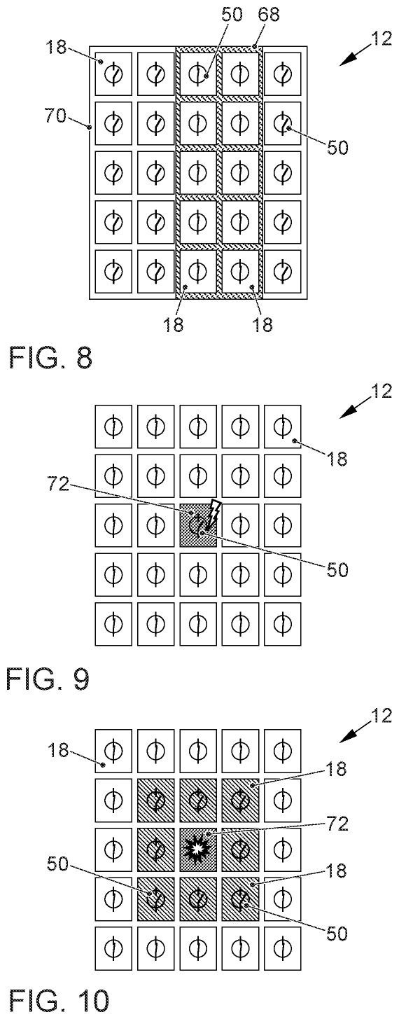

If the temperature of the high-voltage battery 12 is below the limit value again, for example after the motor vehicle 2 has been parked for a relatively long time, method 60 is carried out again and condition 64 is again present. Here, too, initially only the switches 50 of the battery cells 18 assigned to the first group 68 are closed, whereas the battery cells 18 assigned to the second group 70 are disconnected from the interface 16 by means of the respective switches 50 and any other switches 54 being opened until the temperature has increased sufficiently. Compared to the previous implementation of the method 60, however, the division of the individual battery cells 18 between the two groups 68, 70 is changed, as shown in FIG. 8. Thus, each of the battery cells 18 is assigned to the first group 68 at least once in different runs of the method 60. As a result, point loading of the high-voltage battery 12 is avoided and excessive wear and tear of only certain battery cells 18 is avoided. Here again, as also below, disconnection is understood in particular to mean disconnection of the respective galvanic elements 30 of that battery cell 18 for which the switch 50 or the further switch 54 is opened.

In a further alternative, a malfunction of one of the battery cells 18 is used as the condition 64, as shown in FIG. 9. In one embodiment, the switch 50 and any further switch 54 of the malfunctioning battery cell 72 is opened essentially immediately after detection of the malfunction, which was caused, for example, by a short circuit in the galvanic elements 30, so that the battery cell is disconnected from the interface 16. The malfunction, in particular the short circuit, is detected, for example, by means of a corresponding sensor. In a further alternative, the malfunction corresponds, for example, to a fire that is detected on the basis of the temperature increase that has taken place.

In a further development, the switches 50 and any further switches 54 of the remaining battery cells 18 are first opened, and only the switch 50 and the further switch 54 of the malfunctioning battery cell 72 remain closed. The electrical power that can be called up at the interface 16 is thus only provided by means of the malfunctioning battery cell 72, so that it is discharged relatively quickly, in particular if the drive 6 is actuated. If the drive 6 is not actuated, for example because the motor vehicle 2 is parked, the high-voltage battery 12 transmits a request to an on-board computer of the motor vehicle 2 to switch on a consumer, for example a heater, such as a seat or window heater, or an air conditioning system. The power from the malfunctioning battery cell 72 is thus drawn from the high-voltage battery 12. If only relatively little electrical power is stored within the malfunctioning battery cell 72 due to the power being drawn, and if this is in particular less than a certain limit value, the switch 50 and any other switch 54 of the malfunctioning battery cell 72 are opened and thus disconnected from the interface 16. The switches 50 and the further switches 54 of the remaining battery cells 18 are closed, so that the electrical power which can be called up at the interface 16 is provided by means of them. The switches 50, 54 of the malfunctioning battery cell 72, on the other hand, are no longer actuated, so that they, that is their galvanic elements 30, are permanently disconnected from the interface 16, at least until they are in a workshop.

In a modification, which is shown in FIG. 10, not only is the malfunctioning battery cell 72 first of all withdrawn from the electrical power and then disconnected from the interface 16. The battery cells 18 surrounding the malfunctioning battery cell 72 are also first discharged by actuating the switches 50, 54 of the high-voltage battery 12 and then in turn disconnected from the interface 16 by actuation of the switches 50 and any other switches 54 of the high-voltage battery 12. By contrast, all of the remaining battery cells 18 are used for the further operation of the motor vehicle 2. There is thus no further thermal loading of the malfunctioning battery cell 72 because of the battery cells 18 that are still used for operating the motor vehicle 2.

In an alternative to this, after the malfunction has been detected, all battery cells 18 are discharged simultaneously or at least after the malfunctioning battery cells have been discharged, for which purpose the switches 50 and any other switches 54 are suitably actuated. Following this, a corresponding monitoring routine is used to check which of the battery cells 18, in addition to the malfunctioning battery 72, have been damaged due to their malfunction. In the case of these battery cells 18, the switches 50 and any other switches 54 remain open. In the case of the remaining battery cells 18, however, the switches 50 and the further switches 54 are closed, so that further operation of the motor vehicle 2 is also possible even if the high-voltage battery 12 has a reduced capacity.

The invention is not restricted to the embodiments described above. Rather, other variants of the invention can also be derived therefrom by a person skilled in the art without departing from the subject matter of the invention. In particular, all of the individual features described in connection with the individual embodiments can also be combined with one another in other ways without departing from the subject matter of the invention.

### LIST OF REFERENCE SIGNS

2 Motor vehicle
4 Wheel
6 Drive
8 Electric motor
10 Converter
12 High-voltage battery
14 Battery housing
16 Interface
18 Battery cell
20 Housing
22 Housing main body
24 Positive terminal
26 Negative terminal
28 Control terminal
30 Galvanic element
32 Anode
34 Cathode
36 Separator
38 Plastic frame
40 Bipolar plate
42 Rack
44 Chamber
46 First conductor
48 Second conductor
50 Switch
52 Control input
54 Further switch
56 Further control input
58 Further control terminal
60 High-voltage battery
62 First work step
64 Condition
66 Second work step
68 First group
70 Second group
72 Malfunctioning battery cell

1. A high-voltage battery of a motor vehicle, comprising:
at least two battery cells electrically contacted with one another, each having a housing with a positive terminal and a negative terminal, wherein in each housing are arranged a first conductor that is electrically contacted with the positive terminal and a second conductor that is electrically contacted with the negative terminal,
between the first and second conductors, a number of galvanic elements electrically connected in series, each having a cathode, an anode and a separator arranged therebetween, wherein adjacent galvanic elements each abut one another via a bipolar plate, and
wherein a remotely operated switch with a control input is connected between one of the conductors and the associated terminal and is in electrical contact with a control terminal of the housing.

2. The high-voltage battery according to claim 1, wherein each separator is attached at the end to a respective plastic frame, by which the respective cathode is accommodated, the plastic frame being connected to a rack.

3. The high-voltage battery according to claim 1, wherein the switch is connected between the positive terminal and the first conductor.

4. The high-voltage battery according to claim 3, further comprising a second remotely operated switch is connected between the negative terminal and the second conductor to a further control input, which is electrically contacted with the control terminal of the housing.

5. The high-voltage battery according to claim 1, wherein the battery cells are electrically connected in parallel.

6. A method for operating a high-voltage battery according to claim 1, wherein one of the switches is opened if a condition is present.

7. The method according to claim 6, wherein the execution of assembly and/or maintenance is used as the condition, and wherein all switches are opened.

8. The method according to claim 6, wherein a malfunction of one of the battery cells is used as the condition, and wherein the switch of the malfunctioning battery cell is used.

9. The method according to claim 6, wherein the condition used is that a temperature of the high-voltage battery is less than a limit value, at least one of the switches remaining closed.

10. A battery cell of a high-voltage battery according to claim 1.
